(19) United States
(12) Patent Application Publication
(10) Pub. No.: US 2019/0053679 A1
(43) Pub. Date: Feb. 21, 2019

(54) Nozzle Assembly for Cleaning an Opening

(71) Applicant: Chris Calvert, Gilbert, AZ (US)

(72) Inventor: Chris Calvert, Gilbert, AZ (US)

(21) Appl. No.: 16/105,794

(22) Filed: Aug. 20, 2018

Related U.S. Application Data
(60) Provisional application No. 62/548,376, filed on Aug. 21, 2017.

(51) Int. Cl. A47L 9/06; A46B 17/08; A47L 9/24; A46B 5/00; B08B 9/04; B08B 9/035

(52) U.S. Cl. CPC A47L 9/0633; A46B 17/08; A47L 9/0693; A46B 2200/3073; A46B 5/0095; B08B 9/04; B08B 9/035; A47L 9/242

(57) ABSTRACT

The invention involves a nozzle assembly, comprising a nozzle body, and a brush assembly coupled to the nozzle body. The brush assembly includes a threaded fitting and nozzle body coupled thereto. The threaded fitting includes an opening extending therethrough. The nozzle assembly further includes a resilient tube coupled to the threaded fitting. The nozzle assembly is useful for removing dust and debris from openings, such as those formed with a drill and drill bit in concrete.

### CROSS-REFERENCE TO RELATED APPLICATIONS

This invention claims priority to U.S. Provisional Application No. 62/548,376, filed on Aug. 21, 2017, and incorporated herein in its entirety.

### BACKGROUND OF THE INVENTION

### Field of the Invention

This invention relates generally to construction tools.

### Description of the Related Art

In building construction and remodeling, it is often necessary to jack hammer the concrete floor. In some situations, the floor is jack hammered to install piping. A trench is typically formed through the concrete floor and the pipe is installed. After the pipe is installed, it is necessary to reform the floor by pouring concrete into the trench. As is well known, the concrete poured into the trench needs to be supported so it does not settle. It is undesirable to have the concrete settle because then the floor will not be level. Horizontal pieces of support material, such as rebar, are typically installed in the trench to provide support for the poured concrete. The rebar is typically installed in openings that are drilled into the concrete floor. The drilling of the openings typically leaves undesirable debris and dust in the opening. It is desirable to be able to remove the debris and dust from the opening so the rebar can be installed therein without interference. Hence, it is desirable to have a tool that is capable of removing debris and dust from the opening formed in a concrete floor.

### BRIEF SUMMARY OF THE INVENTION

The present invention is directed to a tool that can be used to remove debris and dust from an opening formed in a concrete floor. The novel features of the invention are set forth with particularity in the appended claims. The invention will be best understood from the following description when read in conjunction with the accompanying drawings.

### DETAILED DESCRIPTION OF THE INVENTION

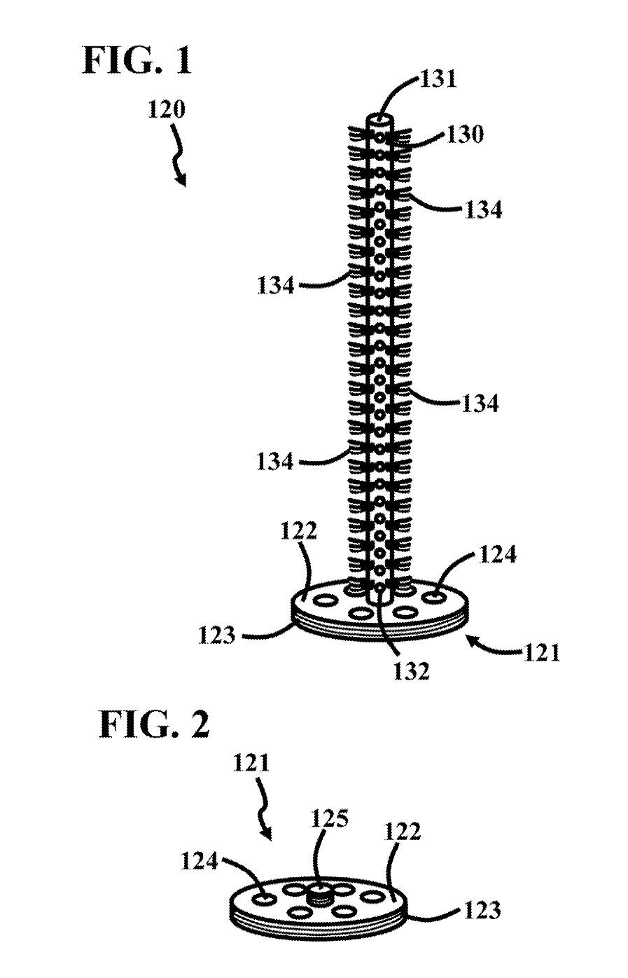

FIG. 1 is a perspective view of a brush assembly 120. In this embodiment, the brush assembly 120 includes a fitting 121. The fitting 121 includes a fitting body 122, which is disk shaped. The fitting 121 includes fitting body threads 123, which extend around the outer periphery of the fitting body 122. The fitting 121 includes fitting body openings 124, which extend therethrough.

The brush assembly 120 includes a nozzle body 130, which is attached to and extends away from the fitting 121. The nozzle body 130 includes a nozzle body end 132, which is positioned proximate to the fitting 121. The nozzle body 130 includes a nozzle body end 131, which is positioned away from the fitting 121. In this embodiment, the brush assembly 120 includes a brush 134, which is connected to the nozzle body 130. In general, the brush assembly 120 can include one or more brushes 134. In this embodiment, the brush assembly 120 includes a plurality of brushes 134 connected to the nozzle body 130. The plurality of brushes 134 extend along the length of the nozzle body 130. Further, the plurality of brushes 134 extend along the outer periphery of the nozzle body 130.

In this embodiment, the nozzle body 130 includes a nozzle body opening 133, which extends therethrough. In general, the nozzle body 130 can include one or more nozzle body openings 133. In this embodiment, the nozzle body 130 includes a plurality of nozzle body openings 133 which extend through the nozzle body 130. The plurality of nozzle body openings 133 are spaced along the length of the nozzle body 130. Further, the nozzle body openings 133 are spaced apart along the outer periphery of the nozzle body 130.

FIG. 2 is a perspective view of a fitting 121 of the brush assembly 120 of FIG. 1. In this embodiment, the fitting 121 includes the fitting body 122, which is disk shaped. The fitting 121 includes fitting body threads 123, which extend around the outer periphery of the fitting body 122. The fitting 121 includes fitting body openings 124, which extend therethrough. Further, the fitting 121 includes nozzle body threads 125, which threadingly engages the nozzle body end 132. In this way, the nozzle body 130 is repeatably moveable between threaded and unthreaded conditions with the fitting 121.

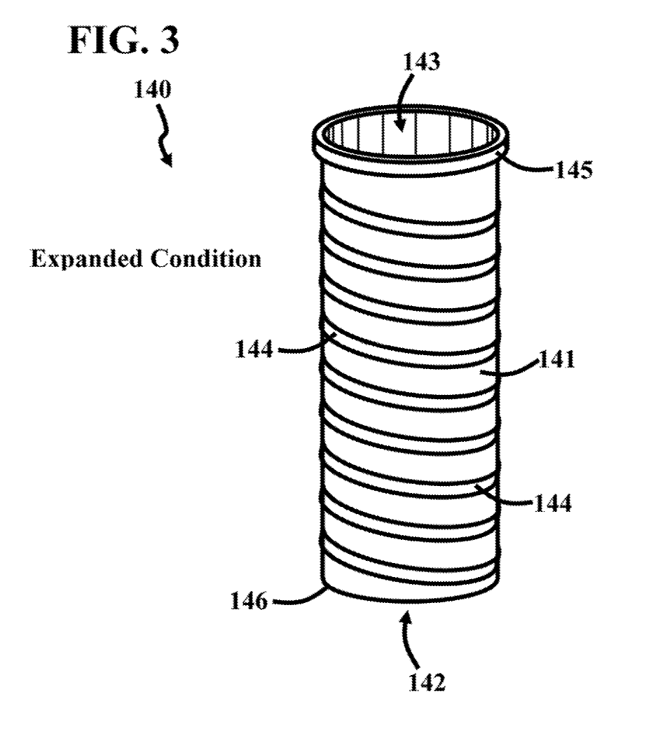

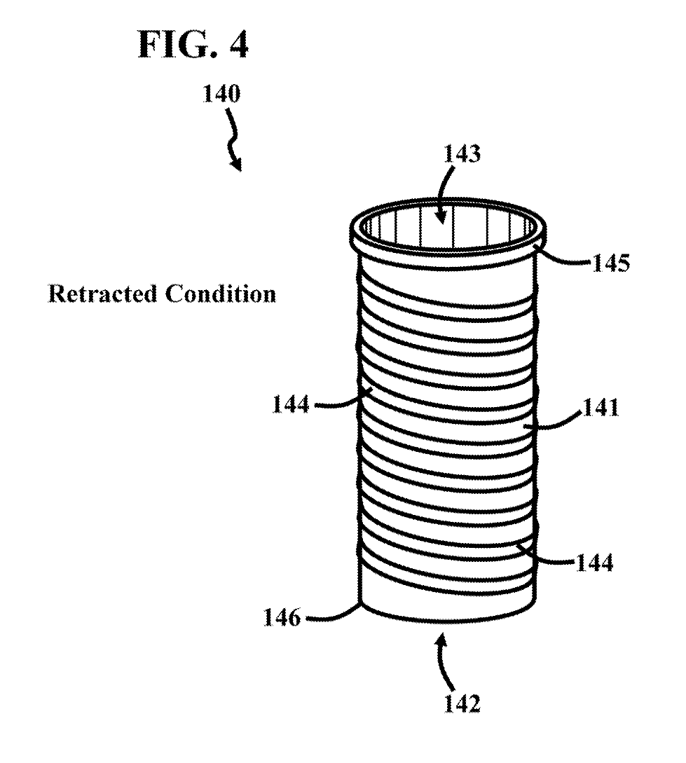

FIGS. 3 and 4 are perspective views of a resilient tube 140, in expanded and retracted conditions, respectively. The resilient tube 140 can be included with the brush assembly 120 of FIG. 1. In this embodiment, the resilient tube 140 includes tube body 141. The tube body 141 can include many different types of material, such as rubber and plastic. The tube body 141 includes opposed tube body openings 142 and 143. The resilient tube 140 includes a resilient member 144, which extends the length of the tube body 141. In this embodiment, the resilient member 144 is helical in shape. The resilient member 144 can include many different types of material, such as metal. In this embodiment, the resilient tube 140 includes a sealing member 145, which is positioned proximate to the tube body opening 143. The resilient tube 140 moves to the retracted condition in response to the opposed tube body openings 142 and 143 moving closer to each other. The resilient tube 140 moves to the expanded condition in response to the opposed tube body openings 142 and 143 moving further away to each other. The resilient tube 140 is repeatably moveable between the expanded and retracted conditions, as will be discussed in more detail below.

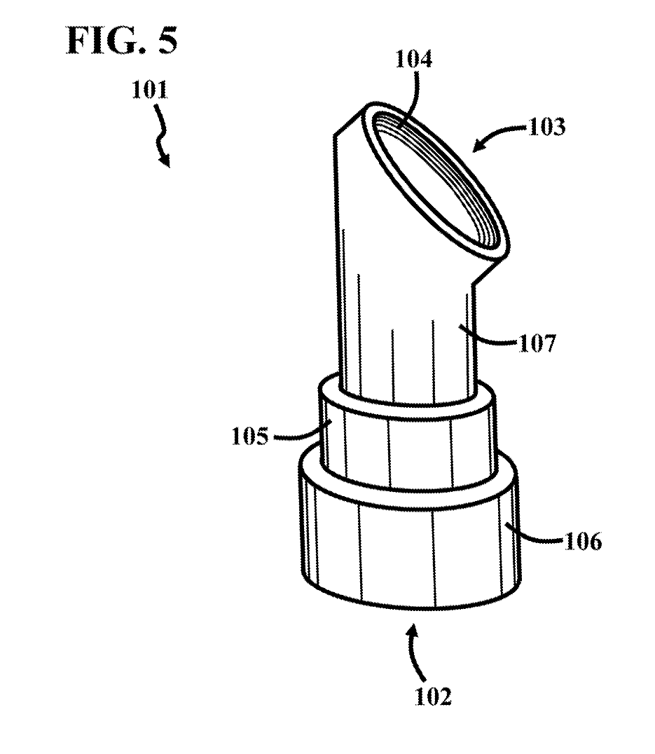

FIG. 5 is a perspective view of a nozzle body 101, which can be included with the brush assembly 120 of FIG. 1. In this embodiment, the nozzle body 101 includes a hose connector 106, which has a nozzle body opening 102 extending therethrough. The nozzle body 101 includes a hose connector 105, which extends from the host connector 106. The inner diameter of the hose connector 105 is smaller than the inner diameter of the hose connector 106 so that the nozzle body 101 can be coupled to different sized hoses. In this embodiment, the nozzle body 101 includes a brush connector 107, which extends from the hose connector 105. The brush connector 107 extends away from the hose connector 106. The brush connector 107 includes a nozzle body opening 103. The inner portion of the brush connector 107 that faces the nozzle body opening 103 includes nozzle body opening threads 104. The nozzle body opening threads 104 are sized and shaped to receive the fitting body threads 123 of FIGS. 1 and 2. In this embodiment, the nozzle body opening 103 faces at an angle relative to the nozzle body opening 102. As will be discussed in more detail below, the nozzle body openings 102 and 103 are opposed to each other in other embodiments.

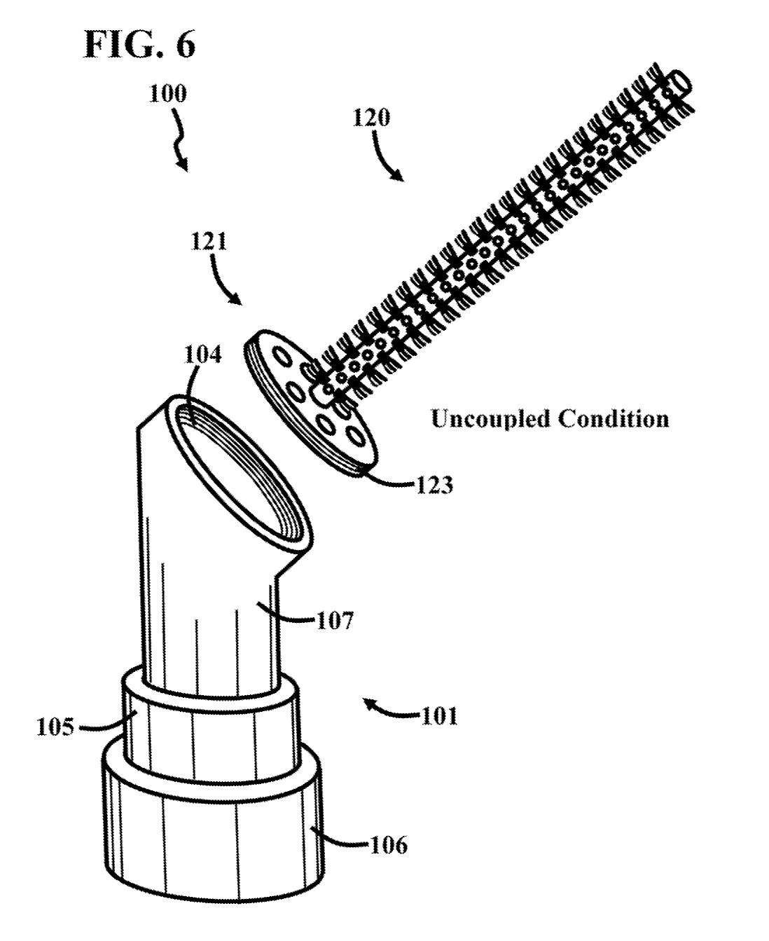

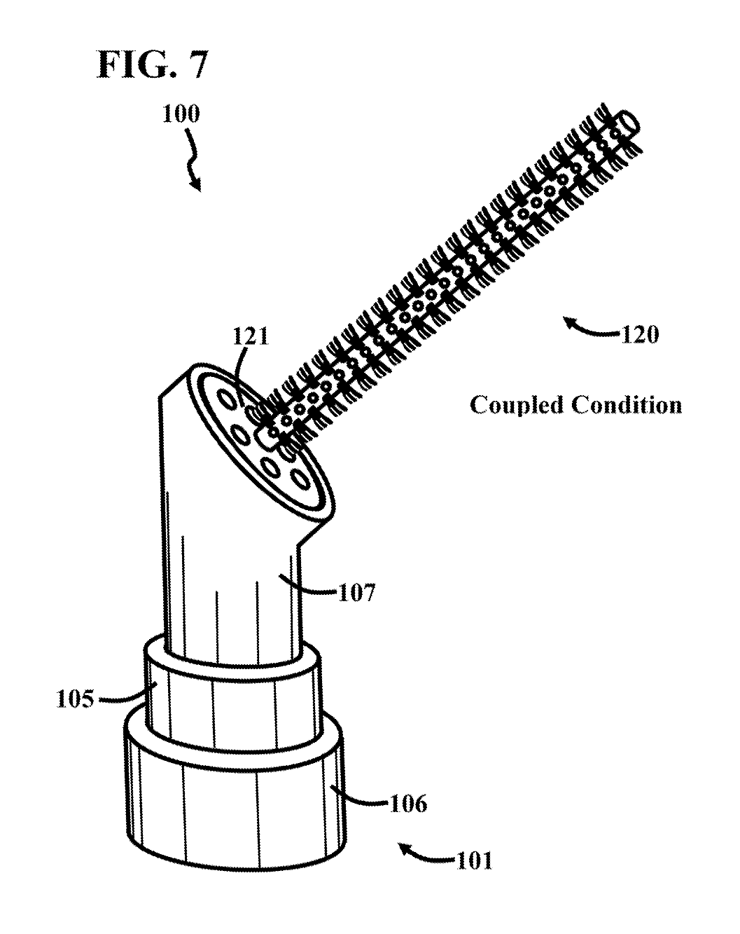

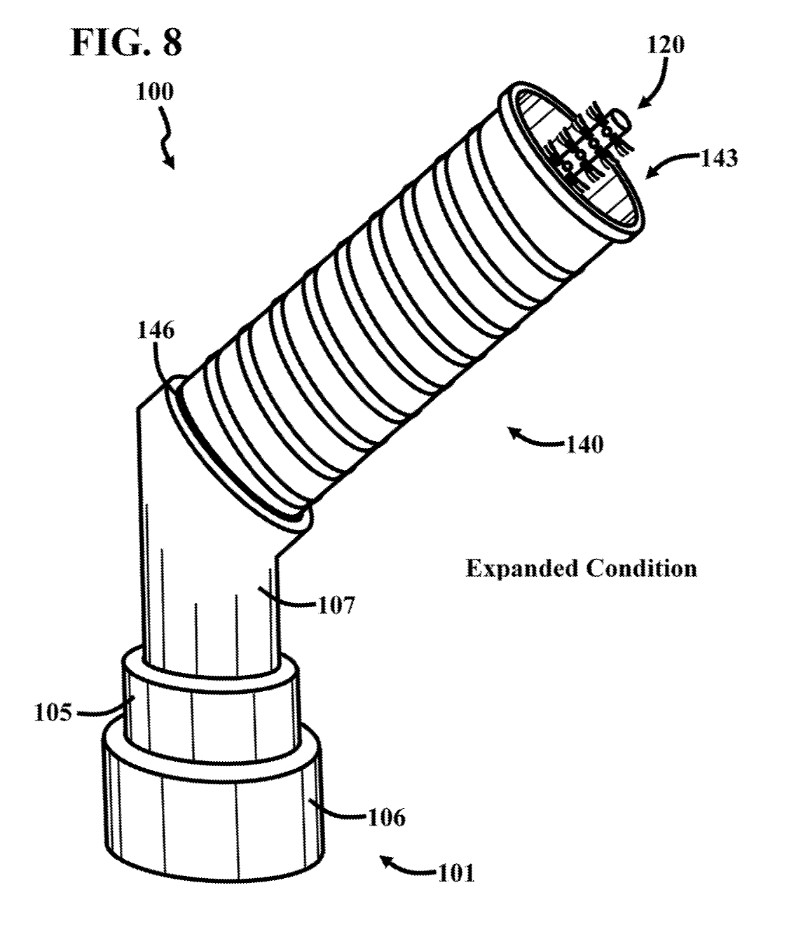

FIGS. 6 and 7 are perspective views of a nozzle assembly 100 in coupled and uncoupled conditions, respectively. In this embodiment, the nozzle assembly 100 includes the nozzle body 101 (FIG. 5) and the brush assembly 120 (FIGS. 1 and 2). The nozzle assembly 100 is repeatably moveable between the coupled and uncoupled conditions. In the uncoupled condition, the brush assembly 120 is away from the nozzle body 101. In particular, the nozzle assembly 100 is in the uncoupled condition when the fitting body threads 123 are threadingly disengaged with the nozzle body opening threads 104. In the coupled condition, the brush assembly 120 is engaged with the nozzle body 101. In particular, the nozzle assembly 100 is in the coupled condition when the fitting body threads 123 are threadingly engaged with the nozzle body opening threads 104.

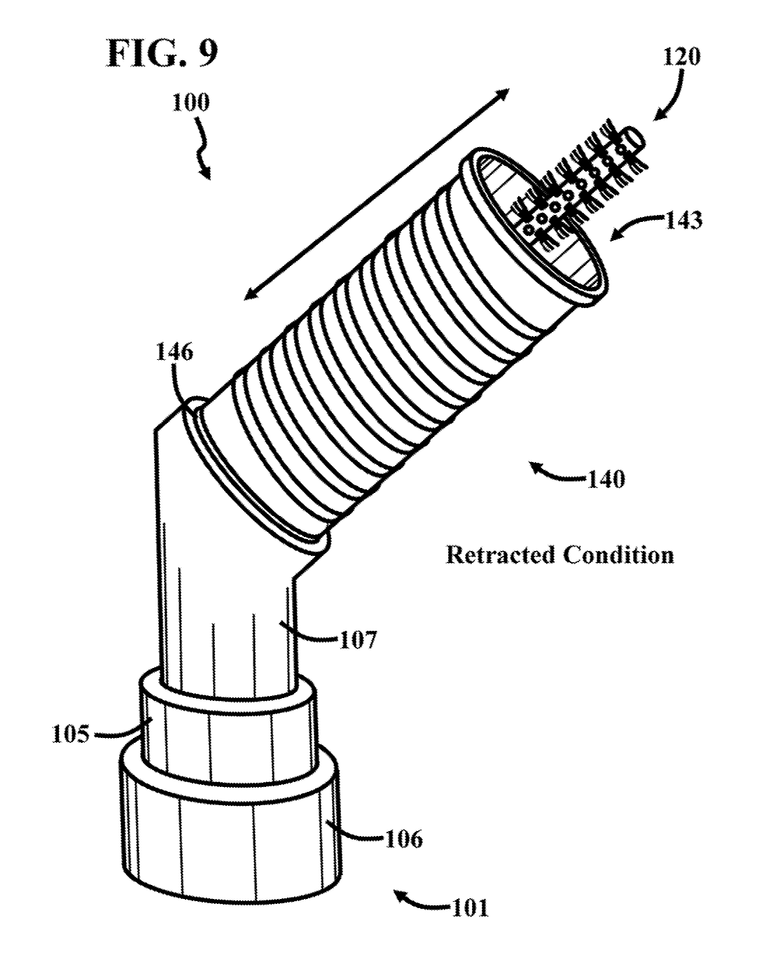

FIGS. 8 and 9 are perspective views of the nozzle assembly 100 of FIGS. 6 and 7, which includes the resilient tube 140 of FIGS. 3 and 4, wherein the resilient tube 140 is in expanded and contracted positions, respectively. As mentioned above, the resilient tube 140 can be included with the brush assembly 120 of FIG. 1. In this embodiment, the resilient tube 140 includes tube body 141. The tube body 141 can include many different types of material, such as rubber and plastic. The tube body 141 includes opposed tube body openings 142 and 143, wherein the tube opening 142 is positioned towards the brush connector 107 and the tube opening 143 is positioned away from the brush connector 107. In particular, the tube opening 142 faces the fitting 121 (FIG. 7). The sealing member 146 engages the brush connector 107. In some embodiments, the sealing member 146 engages the fitting 121.

As mentioned above, the resilient tube 140 includes the resilient member 144, which extends the length of the tube body 141. In this embodiment, the resilient member 144 is helical in shape. The resilient member 144 can include many different types of material, such as metal. In this embodiment, the resilient tube 140 includes the sealing member 145, which is positioned proximate to the tube body opening 143.

The resilient tube 140 moves to the retracted condition in response to the opposed tube body openings 142 and 143 moving closer to each other. The resilient tube 140 moves to the retracted condition in response to the tube body opening 143 moving towards the brush connector 107. In particular, the resilient tube 140 moves to the retracted condition in response to the tube body opening 143 moving towards the fitting 121. The resilient tube 140 moves to the expanded condition in response to the tube body opening 143 moving away from the brush connector 107. In particular, the resilient tube 140 moves to the expanded condition in response to the tube body opening 143 moving away from the fitting 121. The resilient tube 140 moves to the expanded condition in response to the opposed tube body openings 142 and 143 moving further away to each other. The resilient tube 140 is repeatably moveable between the expanded and retracted conditions, as will be discussed in more detail below.

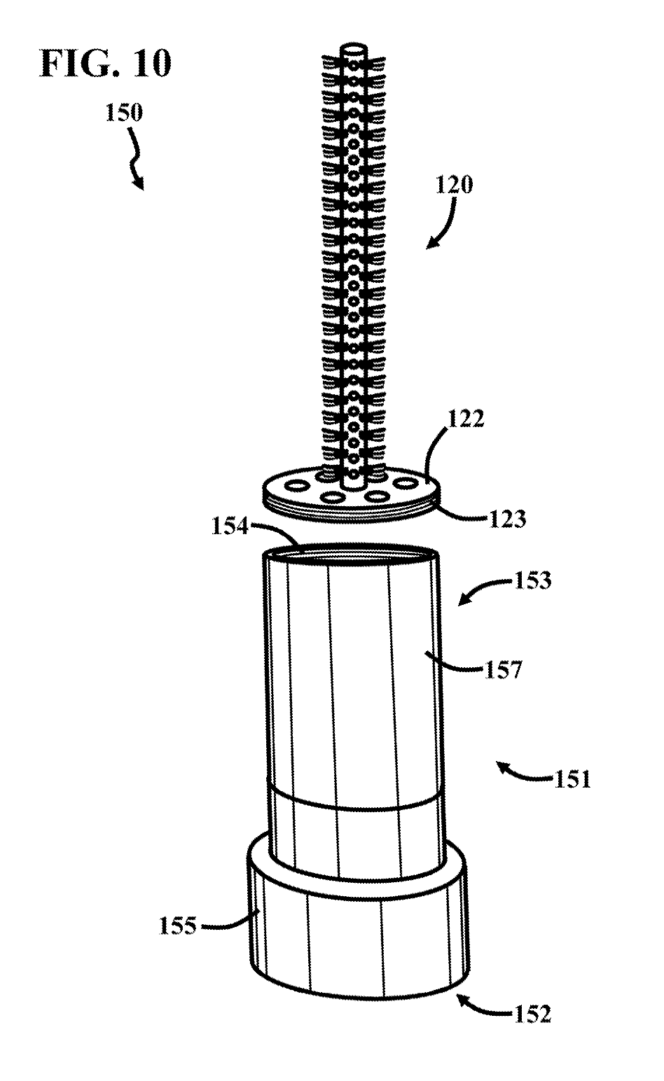

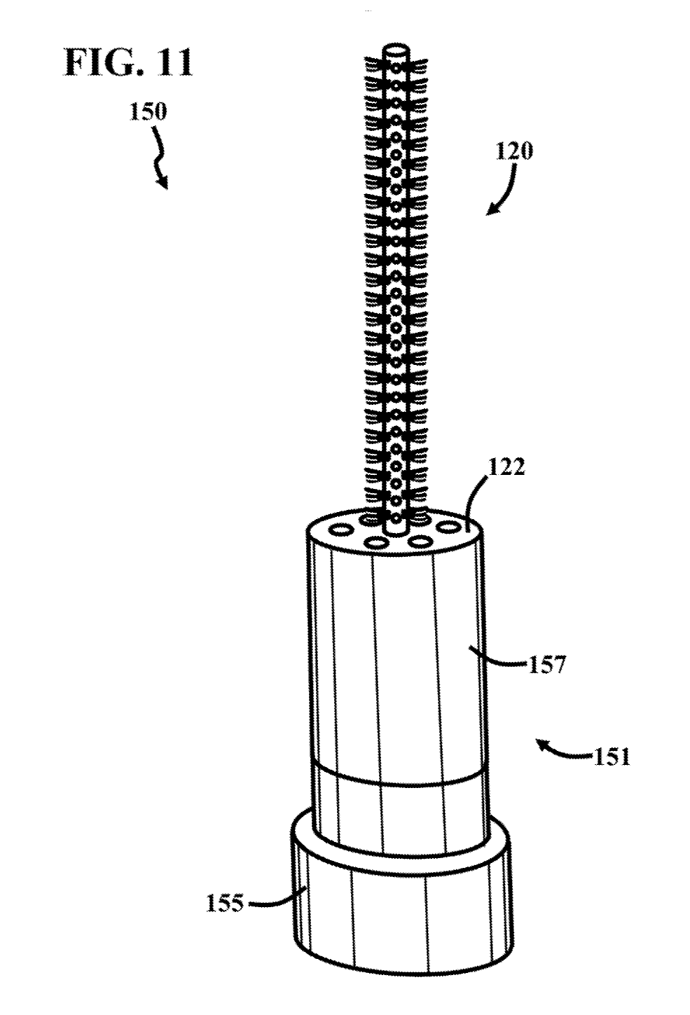

FIGS. 10 and 11 are perspective views of a nozzle assembly 150 in coupled and uncoupled conditions, respectively. In this embodiment, the nozzle assembly 150 includes the nozzle body 151 (FIG. 5) and the brush assembly 120 (FIGS. 1 and 2). In this embodiment, the nozzle body 151 includes a hose connector 155, which has a nozzle body opening 152 extending therethrough. The inner diameter of the hose connector 155 is chosen so it can be connected to a hose. In some embodiments, the nozzle body 151 includes more than one hose connectors.

In this embodiment, the nozzle body 151 includes a brush connector 107, which extends from the hose connector 105. The brush connector 157 extends away from the hose connector 155. The brush connector 157 includes a nozzle body opening 153. The inner portion of the brush connector 157 that faces the nozzle body opening 153 includes nozzle body opening threads 154. The nozzle body opening threads 154 are sized and shaped to receive the fitting body threads 123 of FIGS. 1 and 2. In this embodiment, the nozzle body openings 152 and 153 are opposed to each other. As will be discussed in more detail above, the nozzle body opening 153 faces at an angle relative to the nozzle body opening 152 in other embodiments.

The nozzle assembly 150 is reputably moveable between the coupled and uncoupled conditions. In the uncoupled condition, the brush assembly 120 is away from the nozzle body 151. In particular, the nozzle assembly 150 is in the uncoupled condition when the fitting body threads 123 are threadingly disengaged with the nozzle body opening threads 154. In the coupled condition, the brush assembly 120 is engaged with the nozzle body 151. In particular, the nozzle assembly 150 is in the coupled condition when the fitting body threads 123 are threadingly engaged with the nozzle body opening threads 154.

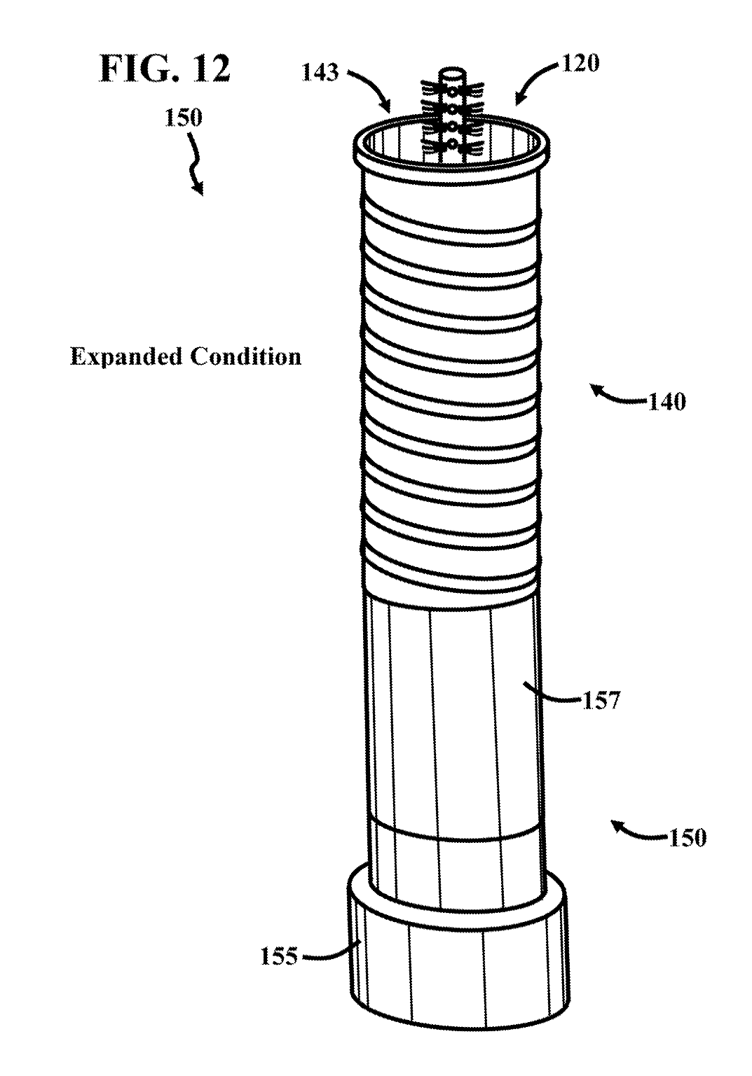

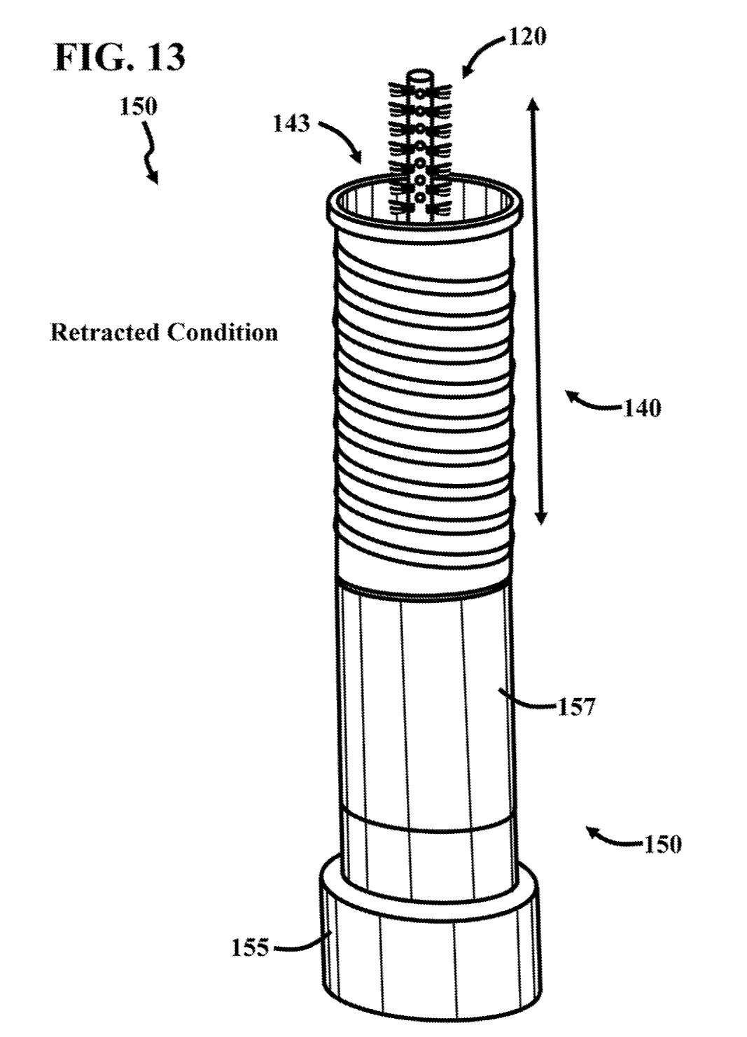

FIGS. 12 and 13 are perspective views of the nozzle assembly 150 of FIGS. 6 and 7, which includes the resilient tube 140 of FIGS. 3 and 4, wherein the resilient tube 140 is in expanded and contracted positions, respectively. As mentioned above, the resilient tube 140 can be included with the brush assembly 120 of FIG. 1. In this embodiment, the resilient tube 140 includes tube body 141. The tube body 141 can include many different types of material, such as rubber and plastic. The tube body 141 includes opposed tube body openings 142 and 143, wherein the tube opening 142 is positioned towards the brush connector 157 and the tube opening 143 is positioned away from the brush connector 157. In particular, the tube opening 142 faces the fitting 121 (FIG. 7). The sealing member 146 engages the brush connector 157. In some embodiments, the sealing member 146 engages the fitting 121.

As mentioned above, the resilient tube 140 includes the resilient member 144, which extends the length of the tube body 141. In this embodiment, the resilient member 144 is helical in shape. The resilient member 144 can include many different types of material, such as metal. In this embodiment, the resilient tube 140 includes the sealing member 145, which is positioned proximate to the tube body opening 143.

The resilient tube 140 moves to the retracted condition in response to the opposed tube body openings 142 and 143 moving closer to each other. The resilient tube 140 moves to the retracted condition in response to the tube body opening 143 moving towards the brush connector 157. In particular, the resilient tube 140 moves to the retracted condition in response to the tube body opening 143 moving towards the fitting 121. The resilient tube 140 moves to the expanded condition in response to the tube body opening 143 moving away from the brush connector 157. In particular, the resilient tube 140 moves to the expanded condition in response to the tube body opening 143 moving away from the fitting 121. The resilient tube 140 moves to the expanded condition in response to the opposed tube body openings 142 and 143 moving further away to each other. The resilient tube 140 is repeatably moveable between the expanded and retracted conditions, as will be discussed in more detail below.

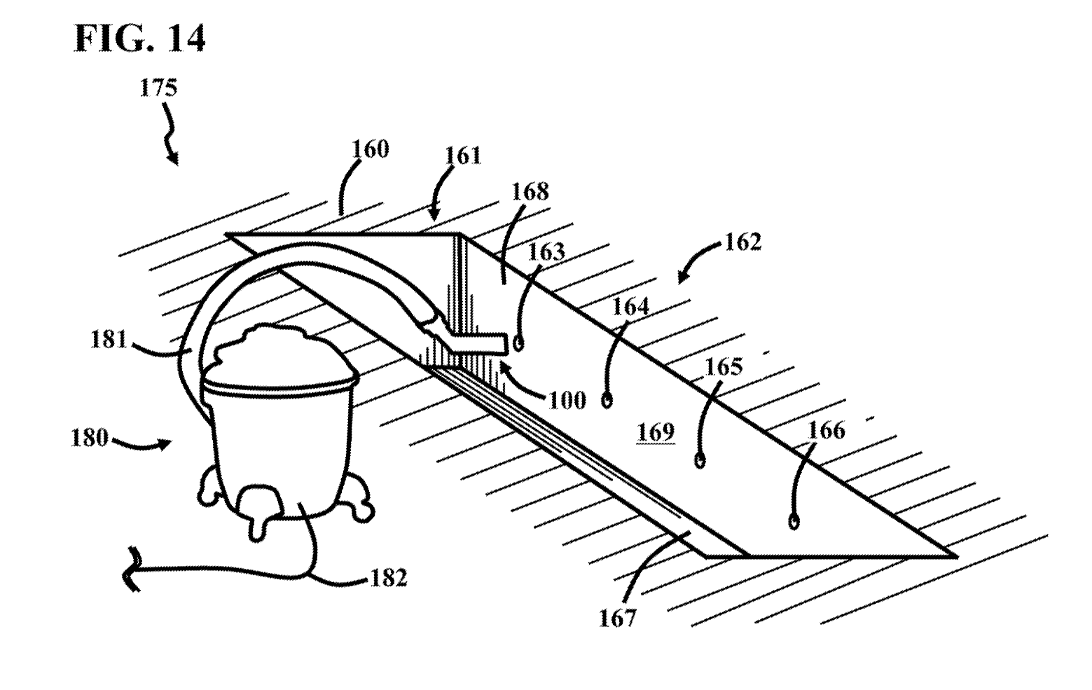

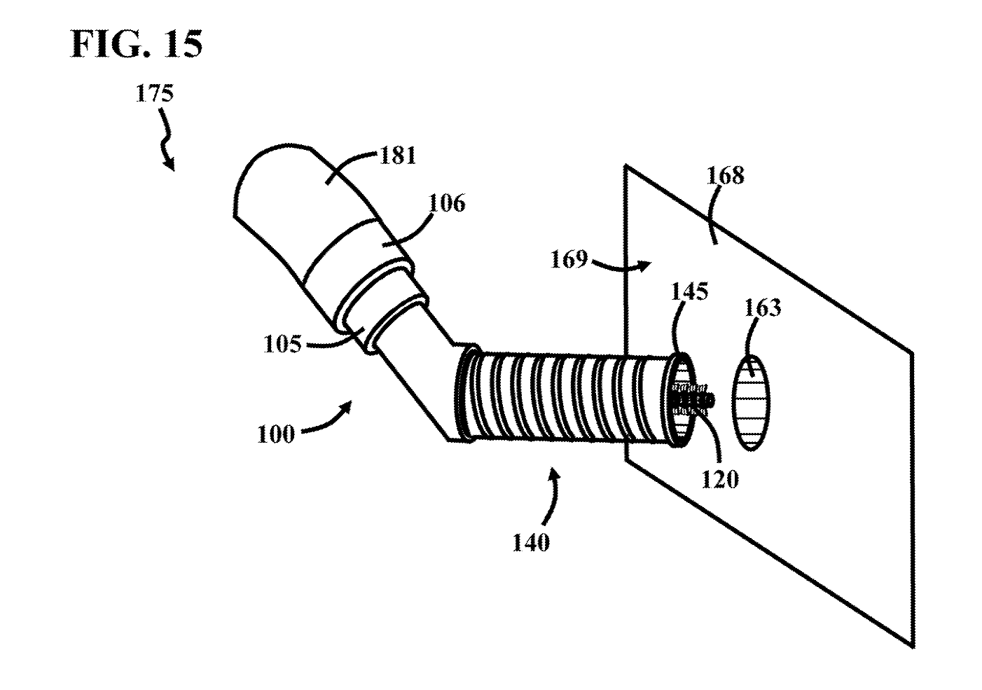

FIG. 14 is a perspective view of a building 175, which includes a concrete floor 160 with a trench 162 formed therein. The trench 162 extends through a concrete floor surface 161 of the concrete floor 160 to a trench surface 167. In this embodiment, the trench 162 includes a trench sidewall 168 with openings 163, 164, 165, and 166 extending therethrough. In particular, the openings 163, 164, 165, and 166 extend through a trench sidewall surface 169 of the trench 162. The openings can be formed in many different ways, such as by drilling using a drill and drill bit (not shown). The drilling process generally leaves debris and dust within the openings 163, 164, 165, and 166, wherein it is desirable to remove the debris and dust therefrom.

In this embodiment, the nozzle assembly 100 is coupled to a vacuum device 180 through a vacuum hose 181. In particular, the distal end of the vacuum hose is coupled to the nozzle body 101, as will be discussed in more detail below. The vacuum device 180 can be of many different types, such as a shop vac, which is powered through a power cord 183.

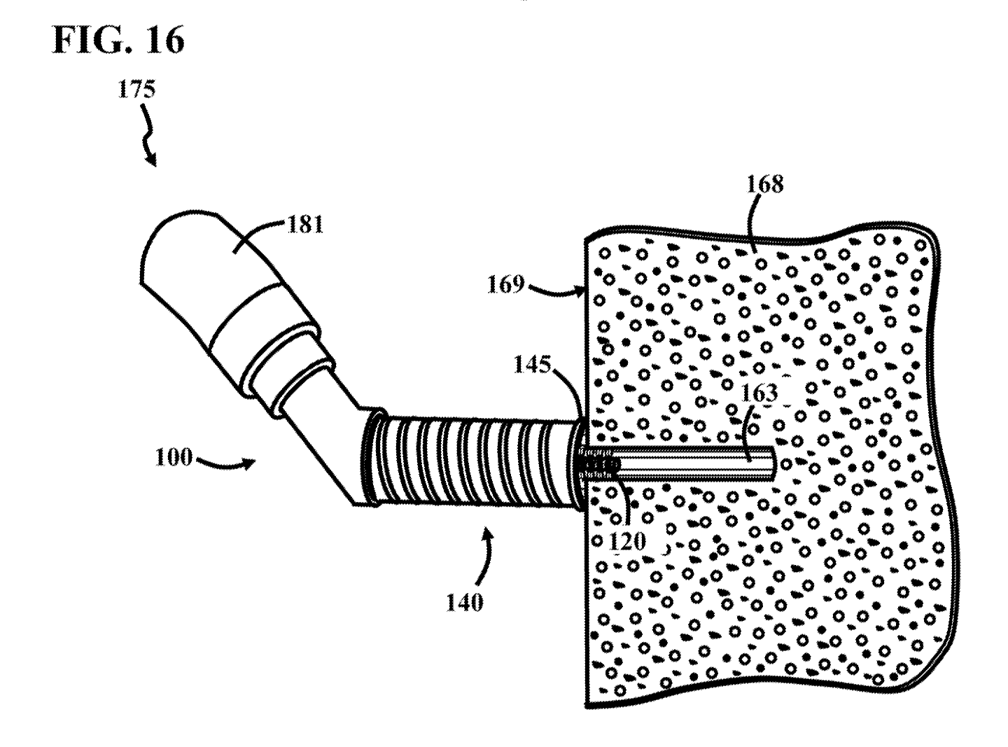

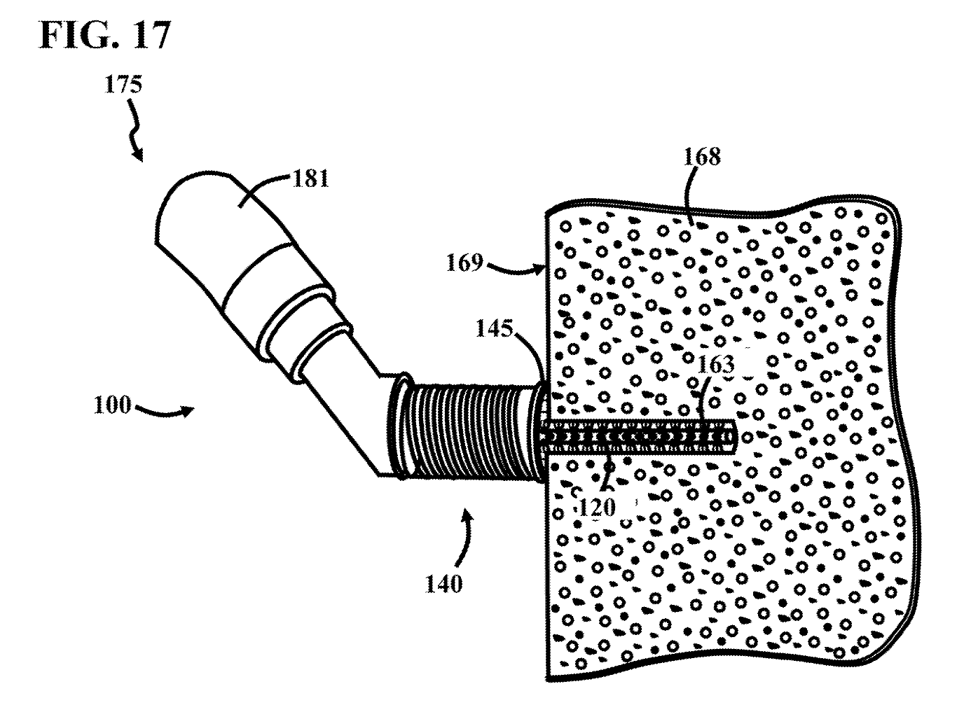

FIG. 15 is a perspective view of the nozzle assembly 100 positioned proximate to the trench sidewall 168 and opening 163. FIGS. 16 and 17 are perspective views of the nozzle assembly 100 engaged with the trench sidewall 168, wherein the nozzle assembly 100 is in the expanded and retracted conditions, respectively.

In this embodiment, the vacuum hose 181 is coupled to the hose connector 106. In other embodiments, the vacuum hose 181 is coupled to the hose connector 105. In operation, the brush assembly 120 and resilient tube 140 are aligned with the opening 163. The brush assembly 120 is moved through the trench sidewall 168 and opening 163, as shown in FIG. 16. The brush assembly 120 is moved through the trench sidewall 168 and opening 163 so that the resilient tube 140 engages the trench sidewall 168, as shown in FIG. 17. The brush assembly 120 is moved through the trench sidewall 168 and opening 163 so that the sealing member 145 of the resilient tube 140 engages the trench sidewall 168 (FIG. 17). The sealing member 145 engages the trench sidewall 168 and forms a seal therewith (FIG. 17).

The vacuum device 180 provides a vacuum through the vacuum hose 181 and, in response, the debris and dust within the opening 183 moves through the opening 183, nozzle assembly 100, and vacuum hose 181. It should be noted that the dust and debris flows through the fitting body openings 124.

Further, the brush assembly 120 engages the outer periphery of the opening 183 to remove dust and debris therefrom. In particular, the brushes 134 engage the outer periphery of the opening 183. The brush assembly 120 facilitates the removal of dust and debris from the opening 183 by loosening it. In some situations, the brush assembly 120 decreases the size of the debris so it is easier to remove from the opening 183. In this way, the nozzle assembly 100 is used to remove debris and dust from an opening formed in a concrete floor.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A nozzle assembly, comprising:
a nozzle body; and
a brush assembly coupled to the nozzle body, wherein the brush assembly 120 includes a fitting body and nozzle body coupled thereto, the fitting body including an opening extending therethrough.

2. The nozzle assembly of claim 1, further including a resilient tube coupled to the fitting body.

3. The nozzle assembly of claim 2, wherein the resilient tube includes a tube body with a resilient member extending therethrough.

4. The nozzle assembly of claim 3, wherein the resilient member is a spring.

5. The nozzle assembly of claim 2, wherein the resilient tube includes first and second sealing members positioned proximate to opposed ends thereof

6. The nozzle assembly of claim 1, wherein nozzle body includes an opening extending therethrough.

7. The nozzle assembly of claim 6, further including a brush coupled to the nozzle body proximate to the opening.

8. The nozzle assembly of claim 1, wherein the nozzle body includes first and second hose connectors.

9. The nozzle assembly of claim 8, wherein the nozzle body includes a brush connector 107, and the second hose connector is between the brush connector and first hose connector.

10. A nozzle assembly, comprising:
a nozzle body, which includes first and second hose connectors; and
a brush assembly threadingly coupled to the nozzle body, wherein the brush assembly includes a fitting body and nozzle body coupled together, the fitting body including an opening extending therethrough.

11. The nozzle assembly of claim 10, further including a resilient tube coupled to the fitting body.

12. The nozzle assembly of claim 11, wherein the resilient tube includes a tube body with a spring extending therethrough.

13. The nozzle assembly of claim 11, wherein the resilient tube is repeatably moveable between expanded and retracted conditions.

14. The nozzle assembly of claim 10, wherein the nozzle body includes first and second openings, which are angled relative to each other.

15. The nozzle assembly of claim 10, wherein the first and second hose connectors are different sizes.

16. A nozzle assembly, comprising:
a nozzle body, which includes first and second hose connectors, wherein the first and second hose connectors are different sizes, the nozzle body including a brush connector extending from the second hose connector; and
a brush assembly threadingly coupled to the nozzle body, wherein the brush assembly includes a fitting body and nozzle body coupled together, the fitting body including an opening extending therethrough.

17. The nozzle assembly of claim 16, further including a resilient tube sealingly engaged with the fitting body.

18. The nozzle assembly of claim 17, wherein the resilient tube includes a tube body with a resilient member extending therethrough.

19. The nozzle assembly of claim 16, wherein the nozzle body includes a plurality of openings extending therethrough.

20. The nozzle assembly of claim 19, further including a plurality of brushes coupled to the nozzle body.
